(19) United States
(12) Patent Application Publication
(10) Pub. No.: US 2026/0323512 A1
(43) Pub. Date: Oct. 15, 2026

(54) ENHANCEMENTS ON DOWNLINK MONITORING

(71) Applicant: Nokia Technologies Oy, Espoo (FI)

(72) Inventors: Mads LAURIDSEN, Gistrup (DK); Chunli WU, Beijing (CN); Naizheng ZHENG, Beijing (CN); Daniela LASELVA, Klarup (DK)

(73) Assignee: Nokia Technologies Oy, Espoo (FI)

(21) Appl. No.: 19/483,668

(22) PCT Filed: May 12, 2023
(86) PCT No.: PCT/CN2023/094082

§ 371 Date: Nov. 12, 2025

(51) Int. Cl. H04W 52/02

(52) U.S. Cl. CPC H04W 52/0216; H04W 52/0235

(57) ABSTRACT

Example embodiments of the present disclosure relate to enhancements on DL monitoring. An apparatus receives, from a network device, a first configuration of DTX pattern applied by the network device, a second configuration of DRX pattern applied by the apparatus, and a third configuration of a wake-up signal associated with the DRX pattern. The apparatus determines, based at least on the first configuration and the third configuration, at least one monitoring occasion for a wake-up signal occurs at least partially in a non-active period of the DTX pattern. If the at least one monitoring occasion occurs at least partially in the non-active period of the DTX pattern, the apparatus then determines, based at least on a wake-up signal monitoring rule, whether to monitor the wake-up signal during at least one monitoring occasion and whether to monitor at least partially in at least one on duration of the DRX pattern.

### FIELDS

Various example embodiments of the present disclosure generally relate to the field of telecommunication, and in particular, to methods, devices, apparatuses and computer readable storage media for downlink (DL) monitoring.

### BACKGROUND

Cell discontinuous transmission (DTX) and/or discontinuous reception (DRX) mechanism has been supported in cells for network energy saving, which is applied to at least UE in RRC_CONNECTED mode. Cell DTX and Cell DRX modes may be configured and operated separately, for example, one RRC configuration set for DL and another for UL. Alternatively, cell DTX and Cell DRX modes may also be configured and operated together. In cell DTX, a cell is configured to be active for a duration (which is also referred to as an active period of a cell DTX pattern) in which the cell is to transmit user data traffic, control signaling, and reference signals are allowed, while to be inactive (i.e., non-active) for the rest of a period (which is also referred to as a non-active period of a DTX pattern) in which the gNB turns off, partially or completely, the above transmissions. The gNB is then able to enter a sleep state, and thereby saving energy during these non-active periods.

Cell DTX/DRX mechanism includes the alignment of cell DTX/DRX and UE DRX in RRC_CONNECTED mode, and inter-node information exchange on cell DTX/eDRX. For a UE operating in DRX in RRC_CONNECTED mode (which is also referred to as C-DRX), a wake-up signal (WUS), also called “downlink control information (DCI) with Cyclic Redundancy Check (CRC) scrambled by Power Saving-Radio Network Temporary Identity (RNTI)” (DCP), may be received prior to an on duration of the DRX pattern. The DCP informs the UE of whether it shall monitor the Physical Downlink Control Channel (PDCCH) during that coming on duration or skip to a next on duration of a next DRX cycle. Since DCP monitoring occasions are not necessarily configured during the cell active period(s) of the DTX pattern, DL monitoring needs to be improved in connection with cell DTX.

### SUMMARY

In a first aspect of the present disclosure, there is provided an apparatus. The apparatus comprises at least one processor; and at least one memory storing instructions that, when executed by the at least one processor, cause the apparatus at least to: receive, from a network device serving the apparatus, a first configuration of a discontinuous transmission, DTX, pattern applied by the network device, a second configuration of a discontinuous reception, DRX, pattern applied by the apparatus, and a third configuration of a wake-up signal associated with the DRX pattern; determine, based at least on the first configuration and the third configuration, at least one monitoring occasion for a wake-up signal occurs at least partially in a non-active period of the DTX pattern; and in accordance with a determination that the at least one monitoring occasion occurs at least partially in the non-active period of the DTX pattern, determine, based on the first configuration, the second configuration, the third configuration and a wake-up signal monitoring rule, whether to monitor the wake-up signal during at least one monitoring occasion and whether to monitor at least partially in at least one on duration of the DRX pattern.

In a second aspect of the present disclosure, there is provided an apparatus. The apparatus comprises at least one processor; and at least one memory storing instructions that, when executed by the at least one processor, cause the apparatus at least to: transmit, to a terminal device served by the apparatus, a first configuration of a discontinuous transmission, DTX, pattern applied by the apparatus, a second configuration of a discontinuous reception, DRX, pattern applied by the terminal device, and a third configuration of a wake-up signal associated with the DRX pattern; determine whether the terminal device is required to monitor at least partially in at least one on duration of the DRX pattern; and in accordance with a determination that at least one monitoring occasion for the wake-up signal occurring at least partially within a non-active period of the DTX pattern, determine, based on the determination result and a wake-up signal monitoring rule, whether to transmit the wake-up signal.

In a third aspect of the present disclosure, there is provided a method. The method comprises: receiving, at a terminal device and from a network device serving the terminal device, a first configuration of a discontinuous transmission, DTX, pattern applied by the network device, a second configuration of a discontinuous reception, DRX, pattern applied by the terminal device, and a third configuration of a wake-up signal associated with the DRX pattern; and determining, based at least on the first configuration and the third configuration, at least one monitoring occasion for a wake-up signal occurs at least partially in a non-active period of the DTX pattern; and in accordance with a determination that the at least one monitoring occasion occurs at least partially in the non-active period of the DTX pattern, determining, based on the first configuration, the second configuration, the third configuration and a wake-up signal monitoring rule, whether to monitor the wake-up signal during at least one monitoring occasion and whether to monitor at least partially in at least one on duration of the DRX pattern.

In a fourth aspect of the present disclosure, there is provided a method. The method comprises: transmitting, at a network device and to a terminal device served by the network device, a first configuration of a discontinuous transmission, DTX, pattern applied by the network device, a second configuration of a discontinuous reception, DRX, pattern applied by the terminal device, and a third configuration of a wake-up signal associated with the DRX pattern; determining whether the terminal device is required to monitor at least partially in at least one on duration of the DRX pattern; and in accordance with a determination that at least one monitoring occasion for the wake-up signal occurring at least partially within a non-active period of the DTX pattern, determining, based on the determination result and a wake-up signal monitoring rule, whether to transmit the wake-up signal.

In a fifth aspect of the present disclosure, there is provided a first apparatus. The first apparatus comprises means for means for receiving, from a network device serving the first apparatus, a first configuration of a discontinuous transmission, DTX, pattern applied by the network device, a second configuration of a discontinuous reception, DRX, pattern applied by the first apparatus, and a third configuration of a wake-up signal associated with the DRX pattern; means for determining, based at least on the first configuration and the third configuration, at least one monitoring occasion for a wake-up signal occurs at least partially in a non-active period of the DTX pattern; and means for in accordance with a determination that the at least one monitoring occasion occurs at least partially in the non-active period of the DTX pattern, determining, based on the first configuration, the second configuration, the third configuration and a wake-up signal monitoring rule, whether to monitor the wake-up signal during at least one monitoring occasion and whether to monitor at least partially in at least one on duration of the DRX pattern.

In a sixth aspect of the present disclosure, there is provided a second apparatus. The second apparatus comprises means for transmitting, to a terminal device served by the second apparatus, a first configuration of a discontinuous transmission, DTX, pattern applied by the second apparatus, a second configuration of a discontinuous reception, DRX, pattern applied by the terminal device, and a third configuration of a wake-up signal associated with the DRX pattern; means for determining whether the terminal device is required to monitor at least partially in at least one on duration of the DRX pattern; and means for in accordance with a determination that at least one monitoring occasion for the wake-up signal occurring at least partially within a non-active period of the DTX pattern, determining, based on the determination result and a wake-up signal monitoring rule, whether to transmit the wake-up signal.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a schematic diagram of example wake-up signal functionality for C-DRX according to some example embodiments of the present disclosure;

FIG. 3 illustrates a signaling chart for a communication process according to some example embodiments of the present disclosure;

FIG. 4A illustrates a schematic diagram of an example wake-up signal monitoring rule according to some example embodiments of the present disclosure;

FIG. 4B illustrates a schematic diagram of an example wake-up signal monitoring rule according to some example embodiments of the present disclosure;

FIG. 5 illustrates a schematic diagram of an example wake-up signal monitoring rule according to some example embodiments of the present disclosure;

FIG. 6 illustrates a schematic diagram of an example wake-up signal monitoring rule according to some example embodiments of the present disclosure;

FIG. 7 illustrates a schematic diagram of an example wake-up signal monitoring rule according to some example embodiments of the present disclosure;

FIG. 8 illustrates a flowchart of a method implemented at an apparatus according to some example embodiments of the present disclosure;

FIG. 9 illustrates a flowchart of a method implemented at an apparatus according to some example embodiments of the present disclosure;

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

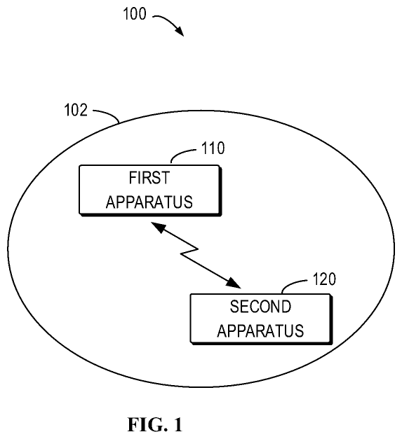

FIG. 1 illustrates an example communication environment 100 in which example embodiments of the present disclosure can be implemented. The communication environment 100 may be a communication network that supports the cell discontinuous reception (DRX)/discontinuous transmission (DTX) mechanism. In the communication environment 100, a first apparatus 110 and a second apparatus 120 may communicate with each other.

The first apparatus 110 may be a terminal device, such as a UE. The first apparatus 110 is configured and operated in a Connected DRX mode, i.e., C-DRX. The configuration of C-DRX may be configured by the second apparatus 120.

The second apparatus 120 may be a network device, such as a gNB. In the example of FIG. 1, the first apparatus 110 locates in a cell 102 provided by the second apparatus 120. In some cases, one or more secondary cell (SCell) may be also configured for the first apparatus 110.

The second apparatus 120 may operate based on cell DRX/DTX mechanism. During cell DTX/DRX non-active periods, the second apparatus 120 may turn off, partially or completely, transmission and reception for user data traffic, control signaling, and reference signals in cell 102, and enter a sleep state. The Cell DTX and Cell DRX modes may be configured and operated separately or together. In the former case, the cell DRX active period might not be aligned with the cell DTX active period. In the context of the example embodiments of present disclosure, the terms “DRX mode” and “DRX pattern” may be used interchangeably. In addition, the terms “DTX mode” and “DTX pattern” may be used interchangeably.

For example, Cell DTX is defined in TR 38.864 as below:

6.1.4.4 Higher layer procedures
Cell DTX/DRX is applied to at least UEs in RRC_CONNECTED state. A periodic Cell DTX/DRX (i.e.,
active and non-active periods) can be configured by gNB via UE-specific RRC signalling per serving
cell. Below examples on Cell DTX/DRX behaviour during non-active periods are assumed to be possible
options, and the UE behaviour/impact will be studied:
- Example 1: gNB is expected to turn off all transmission and reception for data traffic and reference
signal during Cell DTX/DRX non-active periods.
- Example 2: gNB is expected to turn off its transmission/reception only for data traffic during Cell
DTX/DRX non-active periods (i.e., gNB will still transmit/receive reference signals)
- Example 3: gNB is expected to turn off its dynamic data transmission/reception during Cell
DTX/DRX non-active periods (i.e., gNB is expected to still perform transmission/reception in periodic
resources, including SPS, CG-PUSCH, SR, RACH, and SRS).
- Example 4: gNB is expected to only transmit reference signals (e.g., CSI-RS for measurement).
The study focus on UE behavior when at any point in time the cell activates a single DTX/DRX
configuration. It is up to NW whether legacy UEs can access cells with Cell DTX/DRX.
The Cell DTX/DRX mode can be activated/de-activated via dynamic L1/L2 signalling and UE-specific
RRC signaling. Both UE specific and common L1/L2 signalling can be considered for
activating/deactivating the Cell DTX/DRX mode.
Cell DTX and Cell DRX modes can be configured and operated separately (e.g., one RRC configuration
set for DL and another for UL). Cell DTX/DRX can also be configured and operated together. At least
the following parameters can be configured per Cell DTX/DRX configuration: periodicity, start
slot/offset, on duration. Details related to UE behavior can be discussed during WI phase. Whether to
support multiple Cell DTX/DRX configurations can be discussed later in the WI phase.

As previously mentioned, the DCP may be signaled for informing the UE in the cell of whether to monitor the PDCCH during a coming on duration or skip to a next on duration of a next DRX cycle. The DCP may use DCI format 2_6 (see TS 38.212) and be scrambled with PS-RNTI, which is configurable. The DCP may be transmitted at ps-Offset to the start of an on duration of C-DRX and include a wake-up indication bit for the UE and potentially indication of SCell dormancy. The DCI 2_6 has a configurable size and each UE may be indicated where to look for the wake-up indication bit in the DCI. This enables to subgroup UEs within the DCI. Finally, the network may configure the UE behavior if the DCI 2_6 is not detected, i.e., if UE does not detect the DCI 2_6, the ps-WakeUp configuration bit defines whether the UE wakes up or not.

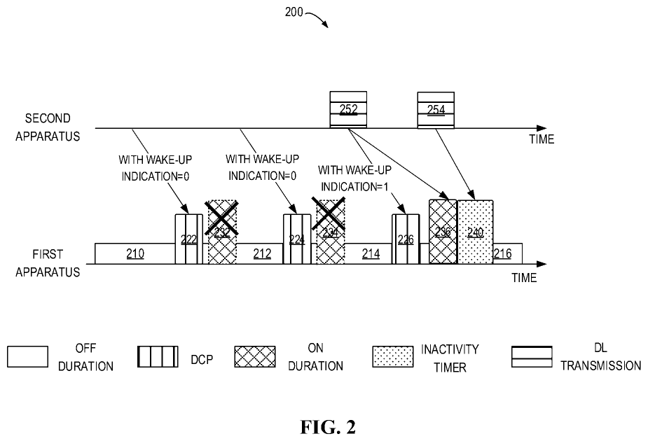

FIG. 2 illustrates a schematic diagram of example wake-up signal functionality 200 for C-DRX according to some example embodiments of the present disclosure. As shown in FIG. 2, the first apparatus 110 may not receive in off durations 210, 212, 214 and 216 of DRX pattern. The monitoring occasions 222, 224 and 226 are configured for monitoring DCP from the second apparatus 120. The monitoring occasions 222, 224 and 226 are associated with potential on durations 232, 234 and 236 of DRX pattern respectively.

The second apparatus 120 may transmit a DCP with different wake-up indicators depending on whether there is DL data to be transmitted in the respective on durations. For example, if the second apparatus 120 determines that no DL transmission is to be transmitted in on durations 232 and 234, the DCP including the wake-up indication bit=0 (which may be also referred to as a first indicator) is transmitted during the monitoring occasions 222 and 224, respectively. Accordingly, the first apparatus 110 may skip the PDCCH monitoring during the respective on durations 232 and 234. If the second apparatus 120 determines that there are DL transmissions 252 and 254 to be transmitted, in this case, the first apparatus 110 needs to monitor the PDCCH in the on duration 236, the DCP including the wake-up indication bit=1 (which may be also referred to as a second indicator) is transmitted during the monitoring occasion 226. After successfully decoding the DL transmission 252, an inactivity timer with a duration 240 will run. When the inactivity timer is expired, the first apparatus 110 may enter the off duration 216.

The DCP may be configured in PhysicalCellGroupConfig of the TS 38.331 as below:

DCP-Config-r16 ::= SEQUENCE {

| | |
|---|---|
| ps-RNTI-r16 | RNTI-Value, |
| ps-Offset-r16 | INTEGER (1..120), |
| sizeDCI-2-6-r16 | INTEGER (1..maxDCI-2-6-Size-r16), |
| ps-PositionDCI-2-6-r16 | INTEGER (0..maxDCI-2-6-Size-1-r16), |
| ps-WakeUp-r16 | ENUMERATED {true} OPTIONAL, -- Need S |
| ps-TransmitPeriodicL1-RSRP-r16 | ENUMERATED {true} OPTIONAL, -- Need S |
| ps-TransmitOtherPeriodicCSI-r16 | ENUMERATED {true} OPTIONAL -- Need S |

}
ps-RNTI
RNTI value for scrambling CRC of DCI format 2-6 used for power saving (see TS 38.213 [13], clause 10.1).
ps-Offset
The start of the search-time of DCI format 2-6 with CRC scrambled by PS-RNTI relative to the start of the drx-
onDurationTimer of Long DRX (see TS 38.213 [13], clause 10.3). Value in multiples of 0.125 ms (milliseconds). 1
corresponds to 0.125 ms, 2 corresponds to 0.25 ms, 3 corresponds to 0.375 ms and so on.
ps-WakeUp
Indicates the UE to wake-up if DCI format 2-6 is not detected outside active time (see TS 38.321 [3], clause 5.7). If
the field is absent, the UE does not wake-up if DCI format 2-6 is not detected outside active time.
ps-PositionDCI-2-6
Starting position of UE wakeup and SCell dormancy indication in DCI format 2-6 (see TS 38.213 [13], clause
10.3).
ps-TransmitPeriodicL1-RSRP
Indicates the UE to transmit periodic L1-RSRP report(s) when the drx-onDurationTimer does not start (see TS
38.321 [3], clause 5.7). If the field is absent, the UE does not transmit periodic L1-RSRP report(s) when the drx-
onDurationTimer does not start.
ps-TransmitOtherPeriodicCSI
Indicates the UE to transmit periodic CSI report(s) other than L1-RSRP reports when the drx-onDurationTimer
does not start (see TS 38.321 [3], clause 5.7). If the field is absent, the UE does not transmit periodic CSI report(s)
other than L1-RSRP reports when the drx-onDurationTimer does not start.

The monitoring of DCP in search space sets is defined in TS 38.213 as below, where the example DCP is in DCI format 2_6:

10.3 PDCCH monitoring indication and dormancy/non-dormancy behaviour for SCells
A UE configured with DRX mode operation [11, TS 38.321] can be provided the following
for detection of a DCI format 2_6 in a PDCCH reception on the PCell or on the SpCell [12,
TS 38.331]
- a number of search space sets, by dci-Format2-6, to monitor PDCCH for detection of DCI
format 2_6 on the active DL BWP of the PCell or of the SpCell according to a common
search space as described in clause 10.1
- an offset by ps-Offset indicating a time, where the UE starts monitoring PDCCH for
detection of DCI format 2_6 according to the number of search space sets, prior to a slot
where the drx-onDurationTimer would start on the PCell or on the SpCell [11, TS 38.321]
- for each search space set, the PDCCH monitoring occasions are the ones in the first Tₛ
slots indicated by duration, or Tₛ = 1 slot if duration is not provided, starting from the first
slot of the first Tₛ slots and ending prior to the start of drx-onDurationTimer.
If a UE is provided search space sets to monitor PDCCH for detection of DCI format 2_6 in
the active DL BWP of the PCell or of the SpCell and the UE detects DCI format 2_6, the
physical layer of a UE reports the value of the Wake-up indication bit for the UE to higher
layers [11, TS 38.321] for the next long DRX cycle.
If a UE is provided search space sets to monitor PDCCH for detection of DCI format 2_6 in
the active DL BWP of the PCell or of the SpCell and the UE does not detect DCI format
2_6, the physical layer of the UE does not report a value of the Wake-up indication bit to
higher layers for the next long DRX cycle.
If a UE is provided search space sets to monitor PDCCH for detection of DCI format 2_6 in
the active DL BWP of the PCell or of the SpCell and the UE
- is not required to monitor PDCCH for detection of DCI format 2_6, as described in
clauses 10, 11.1, 12, and in clause 5.7 of [11, TS 38.321] for all corresponding PDCCH
monitoring occasions outside Active Time prior to a next long DRX cycle, or
- does not have any PDCCH monitoring occasions for detection of DCI format 2_6
outside Active Time of a next long DRX cycle
the physical layer of the UE reports a value of 1 for the Wake-up indication bit to higher
layers for the next long DRX cycle.

Based on the above definition of DCP monitoring, if the first apparatus 110 does not have DCP monitoring occasions, it will always report a wake-up indication bit of 1 to higher layers. Accordingly, the first apparatus 110 will monitor the PDCCH in the associated on duration of the DRX pattern.

In some example embodiments, if the first apparatus 110 is a terminal device and the second apparatus 120 is a network device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

It is to be understood that the number of apparatuses and their connections shown in FIG. 1 are only for the purpose of illustration without suggesting any limitation. The communication environment 100 may include any suitable number of apparatuses or devices configured to implementing example embodiments of the present disclosure. Although not shown, it would be appreciated that one or more additional apparatuses or devices may be located in the communication environment 100. It is noted that although illustrated as a terminal device, the first apparatuses 110 may be a device other than the terminal device. Moreover, although illustrated as a network device, the second apparatuses 120 may be a device other than the network device.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G) Third Generation Partnership Project (3GPP) standards, and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Depending on the configuration of cell DTX and the configuration of DCP monitoring, there may be a possible situation where the DL monitoring occasions may occur during non-active periods of cell DTX. For example, all the DL monitoring occasion(s) configured for DCP may fall within the non-active periods of cell DTX, while the UE's on duration of C-DRX is configured in the active period of cell DTX.

In the above situation, the UE may not receive the DCP, and thus it has to always wake up for the associated on duration according to the current DCP monitoring behavior. This will lead to unnecessary power consumption and waste of energy and resources.

To address the above issue, a straightforward solution is that the network could configure both the DL monitoring occasions for DCP monitoring and UE C-DRX ON-Duration to fall within the active period of cell DTX for each UE configured with DCP. However, this would limit the network flexibility. Furthermore, in scenarios where the alignment of UE C-DRX ON-Duration cannot be achieved, such configuration may entail unnecessary PDCCH monitoring by some UEs.

Therefore, it is necessary to enable UE and network to have a common understanding of whether the UE should monitor the PDCCH in the DRX On Duration in connection with cell DTX.

According to some example embodiments of the present disclosure, there is provided a solution for DL monitoring. In this solution, a first apparatus receives, from a network device serving the apparatus, a first configuration of a discontinuous transmission, DTX, pattern applied by the network device, a second configuration of a discontinuous reception, DRX, pattern applied by the apparatus, and a third configuration of a wake-up signal associated with the DRX pattern. The first apparatus determines, based at least on the first configuration and the third configuration, at least one monitoring occasion for a wake-up signal occurs at least partially in a non-active period of the DTX pattern. In accordance with a determination that the at least one monitoring occasion occurs at least partially in the non-active period of the DTX pattern, the first apparatus determines, based on the first configuration, the second configuration, the third configuration and a wake-up signal monitoring rule, whether to monitor the wake-up signal during at least one monitoring occasion and whether to monitor at least partially in at least one on duration of the DRX pattern.

In this way, the network can control the UE's behavior in DRX, even if the DCP is configured but collides with the cell DTX non-active period. Moreover, in some cases, the network can place the DRX on duration right at the start of the cell DTX active period without having to transmit the DCP, regardless of whether the DCP is configured. Therefore, the DL monitoring can be improved.

Example embodiments of the present disclosure will be described in detail below with reference to the accompanying drawings.

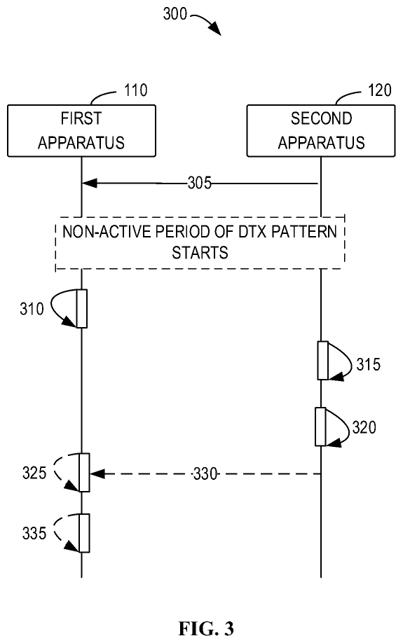

Reference is now made to FIG. 3, which illustrates a signaling chart for a communication process 300 according to some example embodiments of the present disclosure. The communication process 300 may involve a first apparatus (such as, the first apparatus 110) and a second apparatus (e.g., the second apparatus 120). For the purpose of discussion, reference is also made to FIG. 1 to describe the communication process 300.

The second apparatus 120 transmits 305, to the first apparatus 110, a first configuration of a DTX pattern applied by the second apparatus 120, a second configuration of a DRX pattern applied by the first apparatus 110, and a third configuration of a wake-up signal associated with the DRX pattern.

For example, the wake-up signal may be the DCP. In the following embodiments, the wake-up signal may be also referred to as the DCP. However, it should be understood that DCP is given as an example of the wake-up signal, and any other suitable wake-up signal is also applicable to the embodiments of the present disclosure.

In some example embodiments, the first configuration, the second configuration and the third configuration may be configured in separate signalings, or alternatively configured in the same signaling.

After transmitting the configurations, the non-active period of DTX pattern may start, and thus the second apparatus 120 enters a sleep state.

The first apparatus 110 determines 310, based at least on the first configuration and the third configuration, at least one monitoring occasion for a wake-up signal occurs at least partially in a non-active period of the DTX pattern.

The second apparatus 120 may have an analogous understanding. That is, the monitoring occasion(s) for DCP occurs at least partially during a cell DTX non-active period located just before the following UE C-DRX on duration which falls within the next cell DTX active period. In this case, the DL monitoring for wake-up signals and the DL monitoring in C-DRX on-durations may be performed based on a wake-up signal monitoring rule which will be discussed in detail later.

In some example embodiments, the DCP may also contain information on SCell dormancy. If such SCell dormancy indication bits are configured for the first apparatus 110 and the DCP overlaps at least partially with the cell DTX non-active period, the first apparatus 110 shall assume there is no change in the SCell dormancy state.

The second apparatus 120 determines 315 whether the first apparatus 110 is required to monitor at least partially in at least one on duration of the DRX pattern. If there are DL data to be transmitted, then the first apparatus 110 is required to monitor the on duration of the DRX pattern. Otherwise, if there is no DL data to be transmitted, monitoring in the on duration of the DRX pattern may not be required.

The second apparatus 120 then determines 320 whether to transmit the wake-up signal based on the determination result and the wake-up signal monitoring rule. In some example embodiments, the wake-up signal monitoring rule may be preconfigured at the first apparatus 110 (e.g., hard coded). Alternatively, in some other example embodiments, the wake-up signal monitoring rule may be configured by the second apparatus 120. For example, the wake-up signal monitoring rule may be configured as a part of the first configuration of the DTX pattern or the third configuration of the wake-up signal associated with the DRX pattern.

The first apparatus 110 determines 325 based on the first configuration, the second configuration, the third configuration and the wake-up signal monitoring rule, whether to monitor the wake-up signal during at least one monitoring occasion and whether to monitor at least partially in at least one on duration of the DRX pattern.

Accordingly, depending on the configurations and the wake-up signal monitoring rule, in some cases, the first apparatus 110 may then monitor 325 for the wake-up signal during at least one monitoring occasion. If the second apparatus 120 may transmit 330 the wake-up signal before the end of the non-active period of the DTX pattern, the first apparatus 110 may determine 335 whether to monitor at least one on duration of the DRX pattern based on the monitoring result. For example, if the wake-up signal includes the wake-up indication bit=0 (e.g., the first indicator), the first apparatus 110 may then skip to monitor in the following on duration. If the wake-up signal includes the wake-up indication bit=1 (e.g., the second indicator), the first apparatus 110 may then monitor the PDCCH in the following on duration. In some other cases, the first apparatus 110 may skip to monitor during at least one monitoring occasion and skip to monitor in the following on-duration.

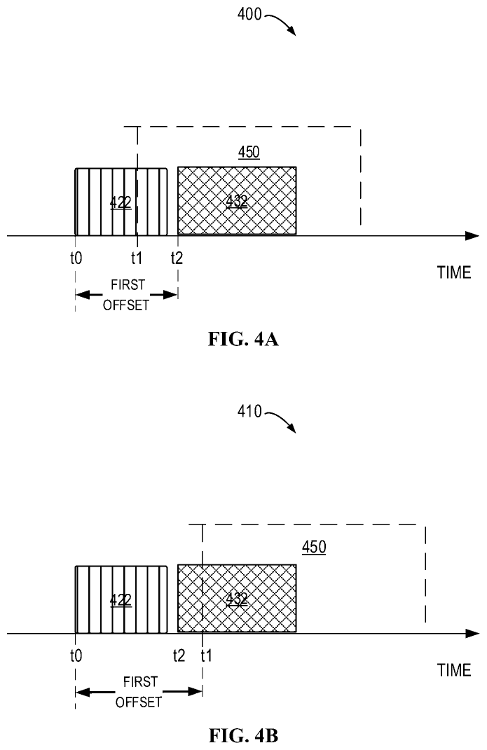

Various examples of the wake-up signal monitoring rule will be described in reference to FIG. 4A to FIG. 7.

In some example embodiments, the configuration of the wake-up signal monitoring rule may comprise a first offset (e.g., ps-Offset) to be applied for monitoring the wake-up signal. Based on the wake-up signal monitoring rule, the first apparatus 110 may start the DCP monitoring at the configured ps-Offset to be applied to the start of max {start of C-DRX On Duration, start of cell DTX active period}, rather than to the start of C-DRX On Duration). The max function is used to determine which of the two “start times” occurs later in time and apply the ps-Offset to the later one, which effectively ensures the DCP occurs as close as possible to the start of the cell DTX active period.

Accordingly, in the above embodiments, the first apparatus 110 may determine, based on the wake-up signal monitoring rule, a later start time from a first on duration of the DRX pattern and a following active period of the DTX pattern. The first on duration is associated with the at least one monitoring occasion for DCP, and is at least partially overlapping with the active period of the DTX pattern. The first apparatus 110 may then start monitoring the wake-up signal at a time that occurs at the first offset before the later start time.

In the example shown in FIG. 4A, a configured monitoring occasion for DCP is associated with a first on-duration 432 of DRX pattern. The following active period 450 of DTX pattern starts at a start time t1, and the first on-duration starts at a start time t2. In this case, the first offset shall be applied to the later start time, i.e., t2, and thereby a start time t0 is derived. The first apparatus 110 starts monitoring for DCP in a monitoring occasion 422 starting from t0.

In the example shown in FIG. 4B, the configured monitoring occasion for DCP is associated with the first on-duration 432 of DRX pattern. The following active period 450 of DTX pattern starts at a start time t1, while the first on-duration starts at a start time t2. In this case, the first offset shall be applied to the later start time, i.e., t1, and thereby a start time t0 is derived. The first apparatus 110 shall start monitoring for DCP in a monitoring occasion 422 starting from to.

Additionally, in some embodiments, the second apparatus 120 may explicitly indicate whether the ps-Offset should be applied to the start of C-DRX On Duration or as per the max function. Alternatively, in some embodiments, a new ps-Offset parameter (e.g., ps-Offset_DTX) may be configured.

In some example embodiments, the configuration of the wake-up signal monitoring rule may comprise a second offset (e.g., (DTX_OnD_offset) to be applied for monitoring the wake-up signal. Based on the wake-up signal monitoring rule, the first apparatus 110 may skip the DCP monitoring and skip the first C-DRX On Duration if a second C-DRX On Duration following the first C-DRX On Duration is within the second offset DTX_OnD_offset from the start of the cell DTX active period.

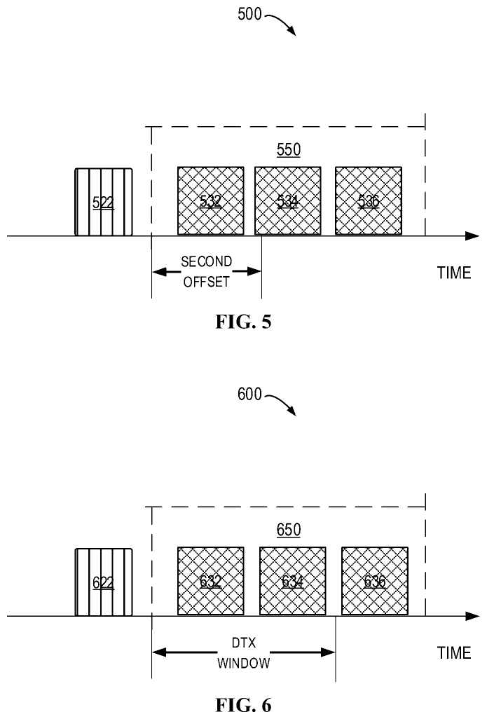

Accordingly, in the above embodiments, the first apparatus 110 may determine, based on the wake-up signal monitoring rule, whether the second on duration in the following active period of the DTX pattern is within the second offset from a start time of the following active period of the DTX pattern. As shown in FIG. 5, on durations 532 to 536 occur within the active period 550 of the DTX pattern, where the monitoring occasion 522 is associated with the first on duration 532. In particular, the second on duration 532 following the first on duration 532 is within the second offset from the start of the active period 550. In this case, the first apparatus 110 may skip to monitor for the wake-up signal during the at least one monitoring occasion and the first on duration of the DRX pattern. The first apparatus 110 may start monitoring for the wake-up signal during a monitoring occasion associated with the second on duration in the following active period of the DTX pattern.

Otherwise, if the second on duration is not within the second offset from the start time of the following active period of the DTX pattern, the first apparatus 110 may start monitoring for the wake-up signal during the at least one monitoring occasion. Depending on the monitoring result of the wake-up signal, the first apparatus 110 may then determine whether to monitor in the following on duration of the DRX pattern. Alternatively, in the case that the second on duration is not within the second offset from the start time of the following active period of the DTX pattern, the first apparatus 110 may skip to monitor in the at least one monitoring occasion, and directly monitor the PDCCH in the first on duration.

Alternatively, in some example embodiments, the configuration of the wake-up signal monitoring rule may comprise a DRX cycle threshold. Based on the wake-up signal monitoring rule, the first apparatus 110 may skip the DCP monitoring and the first C-DRX On Duration if the UE's C-DRX cycle is shorter than the configured DRX cycle threshold.

Accordingly, in the above embodiments, the first apparatus 110 may determine, based on the wake-up signal monitoring rule, whether the DRX cycle of the DRX pattern exceeds the DRX cycle threshold. If the DRX cycle of the DRX pattern does not exceed the DRX cycle threshold, the first apparatus 110 may skip to monitor for the wake-up signal during the at least one monitoring occasion and a first on duration of the DRX pattern associated with the at least one monitoring occasion. The first apparatus 110 may then start monitoring from a second on duration following the first on duration in the following active period of the DTX pattern. Otherwise, if the DRX cycle of the DRX pattern exceeds the DRX cycle threshold, the first apparatus 110 may start monitoring for the wake-up signal during the at least one monitoring occasion. Depending on the monitoring result of the wake-up signal, the first apparatus 110 may determine whether to monitor in the first on duration of the DRX pattern.

In some example embodiments, the configuration of the wake-up signal monitoring rule may comprise a threshold number (e.g., X) of on durations of the DRX pattern. The threshold number may be greater than or equal to 0. Based on the wake-up signal monitoring rule, the first apparatus 110 may skip the DCP monitoring and skip the first C-DRX On Duration if there is at least X other C-DRX On Durations within the cell DTX active period or within a DTX window (e.g., DTX_window seconds) starting from the start of the cell DTX active period. The duration of the DTX window may be the full DTX active period or only a part of the DTX active period.

Accordingly, in the above embodiments, the first apparatus 110 may determine, based on the wake-up signal monitoring rule, whether a number of at least one on duration of the DRX pattern other than a first on duration within at least a part of the following active period of the DTX pattern exceeds the threshold number. As an example, the configured threshold number may be 0, and in the example shown in FIG. 6, on durations 632 to 636 of the DRX pattern is within the active period 650 of DTX pattern, where the monitoring occasion 622 for DCP is associated with the first on duration 632. Because there is one more on duration 634 within the DTX window, that is, the number of on duration(s) other than the first on duration 632 within the active period of the DTX pattern exceeds the threshold number, the first apparatus 110 may skip to monitor during the at least one monitoring occasion 622. Additionally, the first apparatus 110 may start monitoring for the wake-up signal during a monitoring occasion associated with the second on duration 634 following the first on duration 632 of the DRX pattern. Otherwise, if the number of at least one on duration of the DRX pattern does not exceed the threshold number, the first apparatus 110 may start monitoring for the wake-up signal during the at least one monitoring occasion and the first on duration of the DRX pattern. Additionally, the first apparatus 110 may the first apparatus 110 may determine whether to monitor in the first on duration 632 based on a monitoring result of the wake-up signal.

In some example embodiments, the configuration of the wake-up signal monitoring rule may comprise a third offset (e.g., (DCP_DTX_offset) to be applied for monitoring the wake-up signal. Based on the wake-up signal monitoring rule, the first apparatus 110 may monitor for the DCP if at least one monitoring occasion for the DCP is within the third offset DCP DTX offset from the start of the cell DTX active period. In this case, the first apparatus 110 may assume that the network will wake up before the end of the cell DTX non-active period and transmit the DCP if necessary. Depending on the monitoring result of the DCP, the first apparatus 110 may then determine the behavior related to the C-DRX On Duration.

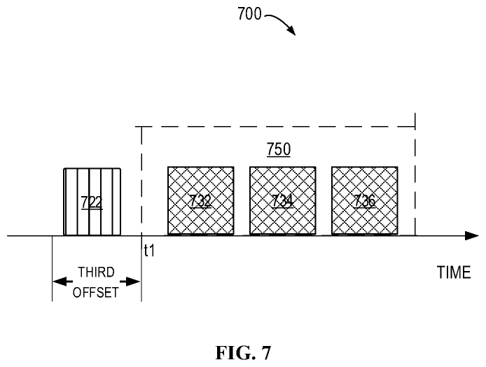

Accordingly, in the above embodiments, the first apparatus 110 may determine, based on the wake-up signal monitoring rule, whether the at least one monitoring occasion for the wake-up signal occurs within the third offset before a start time of a following active period of the DTX pattern. In the example of FIG. 7, on durations 732 to 736 are within the active period 750 of DTX pattern that starts at a start time t1. Because the monitoring occasion 722 occurs within the third offset before the start time t1 of the following active period of the DTX pattern, the first apparatus 110 may start monitoring during the monitoring occasion 722. The first apparatus 110 may determine whether to monitor in the at least one on duration 732 of the DRX pattern based on a monitoring result of the wake-up signal. Otherwise, if the at least one monitoring occasion does not occur within the third offset before the start time of the following active period of the DTX pattern, the first apparatus 110 may skip to monitor during the at least one monitoring occasion and the following on duration of the DRX pattern.

Alternatively, in some other example embodiments, the third offset may be applied to the later one of the start of the start of C-DRX On Duration, start of cell DTX active period, for example, as per the max function. In these embodiments, the first apparatus 110 may determine, based on the first configuration and the second configuration, a later start time from the first on duration of the DRX pattern and the following active period of the DTX pattern. The first apparatus 110 may then determine, based on the wake-up signal monitoring rule, whether the at least one monitoring occasion for the wake-up signal occurs within the third offset before the later start time. The determination of whether to monitor DCP and the DL monitoring in C-DRX on duration are similar to those in previous embodiments.

In some example embodiments, based on the wake-up signal monitoring rule, the first apparatus 110 may monitor the DCP regardless of whether the monitoring occasion(s) for DCP is within the Cell DTX active period or non-active period if its associated C-DRX On Duration is within the Cell DTX active period. The first apparatus 110 may then determine whether to monitor in the at least one on duration of the DRX pattern based on a monitoring result of the wake-up signal. Otherwise, the first apparatus 110 may skip the DCP monitoring if its associated C-DRX On Duration is not within the Cell DTX active period, because then starting of the C-DRX On Duration timer follows legacy procedures.

In some example embodiments, based on the wake-up signal monitoring rule, the first apparatus 110 may skip the DCP monitoring and start the C-DRX On Duration due to missing the associated DCP in Cell DTX non-active period, which is similar to the behavior in the case where the UE missed the associated DCP due to overlapping with UE DRX active time.

In the case where the DCP partially overlaps with the cell DTX active period, for example, as shown in FIG. 4A, if there is any (full or partial) overlap between any monitoring occasion of the search space for the DCP and the cell DTX non-active period, the first apparatus 110 may follow various wake-up signal monitoring rules described in the previous embodiments, that is, the first apparatus 110 may skip to monitor the DCP and apply one of the proposed wake-up signal monitoring rules for the behavior for C-DRX On Duration.

Otherwise, if there is any (full or partial) overlap between any monitoring occasion of the search space for the DCP and the cell DTX active period, the first apparatus 110 may monitor the DCP in that monitoring occasion and follows the legacy behavior.

In the case where the C-DRX On Duration partially overlaps with the cell DTX non-active period, for example, as shown in FIG. 4B, if there is any (full or partial) overlap between the C-DRX On Duration and the cell DTX non-active period, the first apparatus 110 may follow various wake-up signal monitoring rules described in the previous embodiments. In this case, if the first apparatus 110 is further configured to monitor the C-DRX On Duration, the first apparatus 110 may monitor the PDCCH in on durations which occur within the cell DTX active period. Otherwise, if there is any (full or partial) overlap between the C-DRX On Duration and the cell DTX non-active period, the first apparatus 110 may skip the monitoring of the complete C-DRX On Duration, including the part which occurs within the cell DTX active period.

It should be understood that although in the example embodiments, the UE is given as operating in RRC connected mode, the DL monitoring solution provided by the present disclosure can be also applicable to UEs in RRC idle and inactive state if the cell DTX configuration impacts UEs in these RRC states. In one example, the DRX configuration of the UE can correspond to a paging monitoring pattern configuration (e.g., paging cycle) and/or to an enhanced DRX (eDRX) configuration. The wake-up signal can then be a signal associated with the paging monitoring pattern, such as a paging early indication (PEI), controlling whether the UE has to perform paging monitoring or not. In an additional example, the wake-up signal can be a low-power wake-up signal.

It is to be understood that the threshold numbers, configurations, values and functions given in the above embodiments are provided for illustrative purpose. Other threshold numbers, configurations, values and functions may also be applicable to implementations of the embodiments. Therefore, scope of the present disclosure is not limited in this regard.

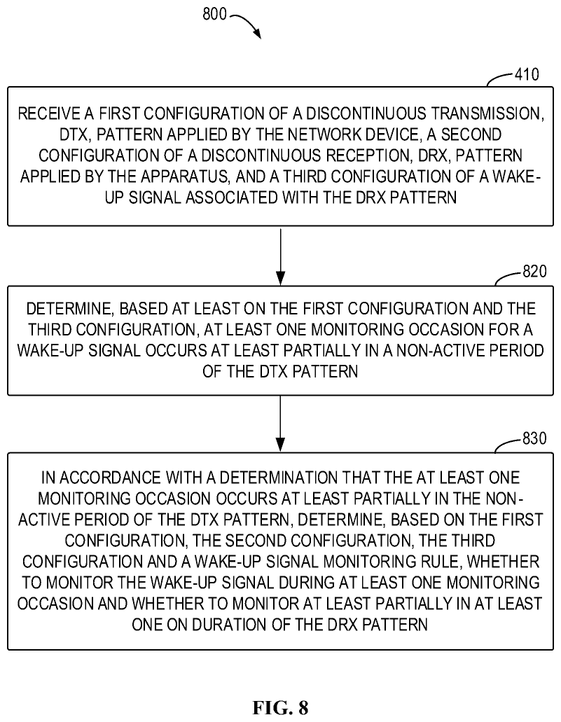

FIG. 8 illustrates a flowchart of a method 800 implemented at an apparatus according to some example embodiments of the present disclosure. For example, the apparatus may be a terminal device, such as, the first apparatus 110 in FIG. 1. For the purpose of discussion, the method 800 will be described from the perspective of the first apparatus 110 in FIG. 1.

At block 810, the apparatus receives, from a network device serving the apparatus, a first configuration of a discontinuous transmission, DTX, pattern applied by the network device, a second configuration of a discontinuous reception, DRX, pattern applied by the apparatus, and a third configuration of a wake-up signal associated with the DRX pattern. For example, the network device may be the second apparatus 120 as shown in FIG. 1.

At block 820, the apparatus determines, based at least on the first configuration and the third configuration, at least one monitoring occasion for a wake-up signal occurs at least partially in a non-active period of the DTX pattern.

In accordance with a determination that the at least one monitoring occasion occurs at least partially in the non-active period of the DTX pattern, at block 830, in the apparatus determines, based on the first configuration, the second configuration, the third configuration and a wake-up signal monitoring rule, whether to monitor the wake-up signal during at least one monitoring occasion and whether to monitor at least partially in at least one on duration of the DRX pattern.

In some example embodiments, the wake-up signal monitoring rule is preconfigured at the apparatus.

In some example embodiments, the wake-up signal monitoring rule is configured as a part of the first configuration of the DTX pattern or the third configuration of the wake-up signal associated with the DRX pattern.

In some example embodiments, a configuration of the wake-up signal monitoring rule comprises a first offset to be applied for monitoring the wake-up signal, and the method 800 further comprises: determining, based on the wake-up signal monitoring rule, a later start time from a first on duration of the DRX pattern and a following active period of the DTX pattern, wherein the first on duration is associated with the at least one monitoring occasion; and starting monitoring the wake-up signal at a time that occurs at the first offset before the later start time.

In some example embodiments, a configuration of the wake-up signal monitoring rule comprises a first offset to be applied to a start time of a first on duration of the DRX pattern associated with the at least one monitoring occasion, and the method 800 further comprises: starting monitoring the wake-up signal at a time that occurs at the first offset before the start time of the first on duration of the DRX pattern.

In some example embodiments, a configuration of the wake-up signal monitoring rule comprises a first offset to be applied to a start time of a following active period of the DTX pattern, and the method 800 further comprises: starting monitoring the wake-up signal at a time that occurs at the first offset before the start time of the following active period of the DTX pattern.

In some example embodiments, a configuration of the wake-up signal monitoring rule comprises a second offset to be applied for monitoring the wake-up signal, and the method 800 further comprises: determining, based on the wake-up signal monitoring rule, whether a second on duration following a first on duration in a following active period of the DTX pattern is within the second offset from a start time of the following active period of the DTX pattern, wherein the first on duration is associated with the at least one monitoring occasion; in accordance with a determination that the second on duration is within the second offset from the start time of the following active period of the DTX pattern, skipping to monitor for the wake-up signal during the at least one monitoring occasion and the first on duration of the DRX pattern, and starting monitoring for the wake-up signal during a monitoring occasion associated with the second on duration in the following active period of the DTX pattern; in accordance with a determination that the second on duration is not within the second offset from the start time of the following active period of the DTX pattern, starting monitoring for the wake-up signal during the at least one monitoring occasion, and determining whether to monitor in the following on duration of the DRX pattern based on a monitoring result of the wake-up signal.

In some example embodiments, a configuration of the wake-up signal monitoring rule comprises a DRX cycle threshold, and the method 800 further comprises: determining, based on the wake-up signal monitoring rule, whether a DRX cycle of the DRX pattern exceed the DRX cycle threshold; in accordance with a determination that the DRX cycle of the DRX pattern does not exceed the DRX cycle threshold, skipping to monitor for the wake-up signal during the at least one monitoring occasion and a first on duration of the DRX pattern associated with the at least one monitoring occasion, starting monitoring for the wake-up signal during a monitoring occasion associated with a second on duration following the first on duration in the following active period of the DTX pattern; and in accordance with a determination that the DRX cycle of the DRX pattern exceeds the DRX cycle threshold, starting monitoring for the wake-up signal during the at least one monitoring occasion; and determining whether to monitor in the first on duration of the DRX pattern based on a monitoring result of the wake-up signal.

In some example embodiments, a configuration of the wake-up signal monitoring rule comprises a threshold number of on durations of the DRX pattern, and the method 800 further comprises: determining, based on the wake-up signal monitoring rule, whether a number of at least one on duration of the DRX pattern other than a first on duration within at least a part of the following active period of the DTX pattern exceeds the threshold number, wherein the first on duration is associated with the at least one monitoring occasion; in accordance with a determination that the number of at least one on duration of the DRX pattern exceeds the threshold number, skipping to monitor during the at least one monitoring occasion and the first on duration of the DRX pattern, and starting monitoring for the wake-up signal during a monitoring occasion associated with a second on duration following the first on duration in the following active period of the DTX pattern; and in accordance with a determination that the number of at least one on duration of the DRX pattern does not exceed the threshold number, starting monitoring for the wake-up signal during the at least one monitoring occasion, and determining whether to monitor in the first on duration of the DRX pattern based on a monitoring result of the wake-up signal.

In some example embodiments, the part of the following active period of the DTX pattern comprises a DTX window starting from a start time of the following active period of the DTX pattern.

In some example embodiments, a configuration of the wake-up signal monitoring rule comprises a third offset to be applied for monitoring the wake-up signal, and the method 800 further comprises: determining, based on the wake-up signal monitoring rule, whether the at least one monitoring occasion for the wake-up signal occurs within the third offset before a start time of a following active period of the DTX pattern; in accordance with a determination that the at least one monitoring occasion occurs within the third offset before the start time of the following active period of the DTX pattern, starting monitoring during the at least one monitoring occasion, and determining whether to monitor in the at least one on duration of the DRX pattern based on a monitoring result of the wake-up signal; and in accordance with a determination that the at least one monitoring occasion does not occur within the third offset before the start time of the following active period of the DTX pattern, skip to monitor during the at least one monitoring occasion and the following on duration of the DRX pattern.

In some example embodiments, a configuration of the wake-up signal monitoring rule comprises a third offset to be applied for monitoring the wake-up signal, and the method 800 further comprises: determining, based on the first configuration and the second configuration, a later start time from a first on duration of the DRX pattern and a following active period of the DTX pattern; determining, based on the wake-up signal monitoring rule, whether the at least one monitoring occasion for the wake-up signal occurs within the third offset before the later start time; in accordance with a determination that the at least one monitoring occasion occurs within the third offset before the later start time, starting monitoring during the at least one monitoring occasion, and determining whether to monitor in the at least one on duration of the DRX pattern based on a monitoring result of the wake-up signal; and in accordance with a determination that the at least one monitoring occasion does not occur within the third offset before the later start time, skipping to monitor during the at least one monitoring occasion and the following on duration of the DRX pattern.

In some example embodiments, the method 800 further comprises: determining, based on the wake-up signal monitoring rule, whether a first on duration of the DRX pattern is within a following active period of the DTX pattern, wherein the at least one monitoring occasion is associated with the following active period of the DTX pattern; in accordance with a determination that the first on duration of the DRX pattern is within a following active period of the DTX pattern, starting monitoring during the at least one monitoring occasion, and determining whether to monitor in the at least one on duration of the DRX pattern based on a monitoring result of the wake-up signal; and in accordance with a determination that the first on duration of the DRX pattern is not within a following active period of the DTX pattern, skipping to monitor during the at least one monitoring occasion and the following on duration of the DRX pattern.

In some example embodiments, the method 800 further comprises: skipping to monitor the wake-up signal during the at least one monitoring occasion; and starting monitoring during a first on duration of the DRX pattern, wherein the first on duration is associated with the at least one monitoring occasion.

In some example embodiments, the method 800 further comprises: determining, based on the wake-up signal monitoring rule, no change in secondary cell dormancy state.

In some example embodiments, the method 800 further comprises: determining, based on the first configuration and the third configuration, the at least one monitoring occasion of a search space for the wake-up signal occurring at least partially within a non-active period of the DTX pattern; starting monitoring the wake-up signal during the at least one monitoring occasion based on the wake-up signal monitoring rule; and determining whether to monitor in the at least one on duration of the DRX pattern based on a monitoring result of the wake-up signal.

In some example embodiments, the method 800 further comprises: determining, based on the first configuration and the second configuration, a first on duration of the DRX pattern is at least partially overlapped with a non-active period of the DTX pattern; and skipping to monitor in the following on duration of the DRX pattern based on the wake-up signal monitoring rule.

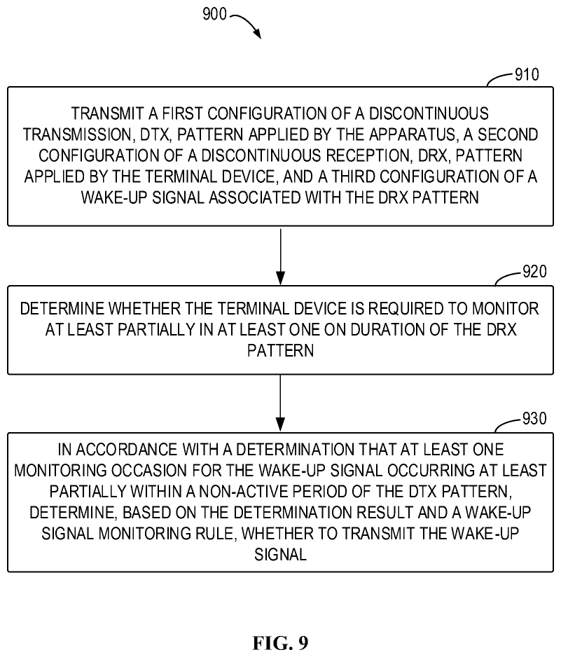

FIG. 9 shows a flowchart of an example method 900 implemented at an apparatus in accordance with some example embodiments of the present disclosure. For example, the apparatus may be a network device, such as, the second apparatus 120 shown in FIG. 1. For the purpose of discussion, the method 900 will be described from the perspective of the second apparatus 120 in FIG. 1.

At block 910, the apparatus transmits, to a terminal device served by the apparatus, a first configuration of a discontinuous transmission, DTX, pattern applied by the apparatus, a second configuration of a discontinuous reception, DRX, pattern applied by the terminal device, and a third configuration of a wake-up signal associated with the DRX pattern. For example, the terminal device may be the first apparatus 110 shown in FIG. 1.

At block 920, the apparatus determines whether the terminal device is required to monitor at least partially in at least one on duration of the DRX pattern.

In accordance with a determination that at least one monitoring occasion for the wake-up signal occurring at least partially within a non-active period of the DTX pattern, at block 930 the apparatus determines, based on the determination result and a wake-up signal monitoring rule, whether to transmit the wake-up signal.

In some example embodiments, the wake-up signal monitoring rule is preconfigured at the apparatus.

In some example embodiments, the wake-up signal monitoring rule is configured as a part of the first configuration of the DTX pattern or the third configuration of the wake-up signal associated with the DRX pattern.

In some example embodiments, a configuration of the wake-up signal monitoring rule comprises a first offset to be applied for monitoring the wake-up signal, and the method 900 further comprises: determining, based on the wake-up signal monitoring rule, at least one transmission occasion starting from a time that occurs at the first offset before a later start time from a first on duration of the DRX pattern and a following active period of the DTX pattern; in accordance with a determination that the terminal device is required to monitor at least partially in at least one on duration of the DRX pattern, transmitting, to the terminal device, the wake-up signal comprising a first indicator during the at least one transmission occasion; and in accordance with a determination that the terminal device is not required to monitor at least partially in at least one on duration of the DRX pattern, transmitting, to the terminal device, the wake-up signal comprising a second indicator during the at least one transmission occasion.

In some example embodiments, a configuration of the wake-up signal monitoring rule comprises a first offset to be applied for monitoring the wake-up signal, and the method 900 further comprises: determining, based on the wake-up signal monitoring rule, at least one transmission occasion starting from a time that occurs at the first offset before a start time of a first on duration of the DRX pattern; in accordance with a determination that the terminal device is required to monitor at least partially in at least one on duration of the DRX pattern, transmitting, to the terminal device, the wake-up signal comprising a first indicator during the at least one transmission occasion; and in accordance with a determination that the terminal device is not required to monitor at least partially in at least one on duration of the DRX pattern, transmitting, to the terminal device, the wake-up signal comprising a second indicator during the at least one transmission occasion.

In some example embodiments, a configuration of the wake-up signal monitoring rule comprises a first offset to be applied for monitoring the wake-up signal, and the method 900 further comprises: determining, based on the wake-up signal monitoring rule, at least one transmission occasion starting from a time that occurs at the first offset before a start time of a following active period of the DTX pattern; in accordance with a determination that the terminal device is required to monitor at least partially in at least one on duration of the DRX pattern, transmitting, to the terminal device, the wake-up signal comprising a first indicator during the at least one transmission occasion; and in accordance with a determination that the terminal device is not required to monitor at least partially in at least one on duration of the DRX pattern, transmitting, to the terminal device, the wake-up signal comprising a second indicator during the at least one transmission occasion.

In some example embodiments, a configuration of the wake-up signal monitoring rule comprises a second offset to be applied for monitoring the wake-up signal, and the method 900 further comprises: determining, based on the wake-up signal monitoring rule, whether a second on duration following a first on duration in a following active period of the DTX pattern is within the second offset from a start time of the following active period of the DTX pattern; in accordance with a determination that the second on duration is within the second offset from the start time of the following active period of the DTX pattern, determining no wake-up signal to be transmitted for the first on duration; and in accordance with a determination that the second on duration is not within the second offset from the start time of the following active period of the DTX pattern, transmitting, to the terminal device, the wake-up signal during at least one monitoring occasion configured for the wake-up signal, the wake-up signal indicative of whether to monitor in the first on duration of the DRX pattern.

In some example embodiments, a configuration of the wake-up signal monitoring rule comprises a DRX cycle threshold, and the method 900 further comprises: determining, based on the wake-up signal monitoring rule, whether a DRX cycle of the DRX pattern exceed the DRX cycle threshold; in accordance with a determination that the DRX cycle of the DRX pattern does not exceed the DRX cycle threshold, determining no wake-up signal to be transmitted; and in accordance with a determination that the DRX cycle of the DRX pattern exceeds the DRX cycle threshold, transmitting, to the terminal device, the wake-up signal during at least one monitoring occasion configured for the wake-up signal, the wake-up signal indicative of whether to monitor in the at least one on duration of the DRX pattern.

In some example embodiments, a configuration of the wake-up signal monitoring rule comprises a threshold number of on durations of the DRX pattern, and the method 900 further comprises: determining, based on the wake-up signal monitoring rule, whether a number of at least one on duration of the DRX pattern other than a first on duration within at least a part of the following active period of the DTX pattern exceeds the threshold number; in accordance with a determination that the number of at least one on duration of the DRX pattern exceeds the threshold number, determining no wake-up signal to be transmitted; and in accordance with a determination that the number of at least one on duration of the DRX pattern does not exceed the threshold number, transmitting, to the terminal device, the wake-up signal during at least one monitoring occasion configured for the wake-up signal, the wake-up signal indicative of whether to monitor in the at least one on duration of the DRX pattern.

In some example embodiments, the part of the following active period of the DTX pattern comprises a DTX window starting from a start time of the following active period of the DTX pattern.

In some example embodiments, a configuration of the wake-up signal monitoring rule comprises a third offset to be applied for monitoring the wake-up signal, and the method 900 further comprises: determining, based on the wake-up signal monitoring rule, whether the at least one monitoring occasion configured for the wake-up signal occurs within the third offset before a start time of a following active period of the DTX pattern; in accordance with a determination that the at least one monitoring occasion occurs within the third offset before the start time of the following active period of the DTX pattern, transmitting the wake-up signal before the end of the non-active period of the DTX pattern, the wake-up signal indicative of whether to monitor in the at least one on duration of the DRX pattern; and in accordance with a determination that the at least one monitoring occasion does not occur within the third offset before the start time of the following active period of the DTX pattern, determining no wake-up signal to be transmitted.

In some example embodiments, a configuration of the wake-up signal monitoring rule comprises a third offset to be applied for monitoring the wake-up signal, and the method 900 further comprises: determining, based on the first configuration and the second configuration, a later start time from a first on duration of the DRX pattern and a following active period of the DTX pattern; determining, based on the wake-up signal monitoring rule, whether the at least one monitoring occasion for the wake-up signal occurs within the third offset before the later start time; in accordance with a determination that the at least one monitoring occasion occurs within the third offset before the later start time, transmitting the wake-up signal before the end of an active period of the DTX pattern, the wake-up signal indicative of whether to monitor in the at least one on duration of the DRX pattern; and in accordance with a determination that the at least one monitoring occasion does not occur within the third offset before the later start time, determining no wake-up signal to be transmitted.

In some example embodiments, the method 900 further comprises: determining, based on the wake-up signal monitoring rule, whether a first on duration of the DRX pattern is within a following active period of the DTX pattern, wherein the at least one monitoring occasion is associated with the following active period of the DTX pattern; in accordance with a determination that the first on duration of the DRX pattern is within a following active period of the DTX pattern, transmitting the wake-up signal before the end of an active period of the DTX pattern, the wake-up signal indicative of whether to monitor in the at least one on duration of the DRX pattern; and in accordance with a determination that the first on duration of the DRX pattern is not within a following active period of the DTX pattern, determining no wake-up signal to be transmitted.

In some example embodiments, the method 900 further comprises: determining, based on the wake-up signal monitoring rule, no wake-up signal to be transmitted.

In some example embodiments, the method 900 further comprises: determining, based on the first configuration and the third configuration, the at least one monitoring occasion of a search space for the wake-up signal occurring at least partially within a non-active period of the DTX pattern; and transmitting the wake-up signal before the end of an active period of the DTX pattern, the wake-up signal indicative of whether to monitor in the at least one on duration of the DRX pattern.

In some example embodiments, the method 900 further comprises: determining, based on the first configuration and the second configuration, a first on duration of the DRX pattern is at least partially overlapped with a non-active period of the DTX pattern; and transmitting the wake-up signal before the end of an active period of the DTX pattern, the wake-up signal indicative of whether to monitor in the at least one on duration of the DRX pattern.

In some example embodiments, an apparatus, which is also referred to as a first apparatus hereafter, capable of performing any of the method 800 (for example, the first apparatus 110 in FIG. 1) may comprise means for performing the respective operations of the method 800. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a network device serving the first apparatus, a first configuration of a discontinuous transmission, DTX, pattern applied by the network device, a second configuration of a discontinuous reception, DRX, pattern applied by the first apparatus, and a third configuration of a wake-up signal associated with the DRX pattern; means for determining, based at least on the first configuration and the third configuration, at least one monitoring occasion for a wake-up signal occurs at least partially in a non-active period of the DTX pattern; and means for in accordance with a determination that the at least one monitoring occasion occurs at least partially in the non-active period of the DTX pattern, determining, based on the first configuration, the second configuration, the third configuration and a wake-up signal monitoring rule, whether to monitor the wake-up signal during at least one monitoring occasion and whether to monitor at least partially in at least one on duration of the DRX pattern.

In some example embodiments, the wake-up signal monitoring rule is preconfigured at the first apparatus.

In some example embodiments, the wake-up signal monitoring rule is configured as a part of the first configuration of the DTX pattern or the third configuration of the wake-up signal associated with the DRX pattern.

In some example embodiments, a configuration of the wake-up signal monitoring rule comprises a first offset to be applied for monitoring the wake-up signal, and wherein the first apparatus further comprises: means for determining, based on the wake-up signal monitoring rule, a later start time from a first on duration of the DRX pattern and a following active period of the DTX pattern, wherein the first on duration is associated with the at least one monitoring occasion; and means for starting monitoring the wake-up signal at a time that occurs at the first offset before the later start time.

In some example embodiments, a configuration of the wake-up signal monitoring rule comprises a first offset to be applied to a start time of a first on duration of the DRX pattern associated with the at least one monitoring occasion, and the first apparatus further comprises: means for starting monitoring the wake-up signal at a time that occurs at the first offset before the start time of the first on duration of the DRX pattern.

In some example embodiments, a configuration of the wake-up signal monitoring rule comprises a first offset to be applied to a start time of a following active period of the DTX pattern, and the first apparatus further comprises: means for starting monitoring the wake-up signal at a time that occurs at the first offset before the start time of the following active period of the DTX pattern.

In some example embodiments, a configuration of the wake-up signal monitoring rule comprises a second offset to be applied for monitoring the wake-up signal, and the first apparatus further comprises: means for determining, based on the wake-up signal monitoring rule, whether a second on duration following a first on duration in a following active period of the DTX pattern is within the second offset from a start time of the following active period of the DTX pattern, wherein the first on duration is associated with the at least one monitoring occasion; means for in accordance with a determination that the second on duration is within the second offset from the start time of the following active period of the DTX pattern, skipping to monitor for the wake-up signal during the at least one monitoring occasion and the first on duration of the DRX pattern; and starting monitoring for the wake-up signal during a monitoring occasion associated with the second on duration in the following active period of the DTX pattern; and means for in accordance with a determination that the second on duration is not within the second offset from the start time of the following active period of the DTX pattern, starting monitoring for the wake-up signal during the at least one monitoring occasion; and determining whether to monitor in the following on duration of the DRX pattern based on a monitoring result of the wake-up signal.

In some example embodiments, a configuration of the wake-up signal monitoring rule comprises a DRX cycle threshold, and the first apparatus further comprises: means for determining, based on the wake-up signal monitoring rule, whether a DRX cycle of the DRX pattern exceed the DRX cycle threshold; means for in accordance with a determination that the DRX cycle of the DRX pattern does not exceed the DRX cycle threshold, skipping to monitor for the wake-up signal during the at least one monitoring occasion and a first on duration of the DRX pattern associated with the at least one monitoring occasion; and starting monitoring for the wake-up signal during a monitoring occasion associated with a second on duration following the first on duration in the following active period of the DTX pattern; and means for in accordance with a determination that the DRX cycle of the DRX pattern exceeds the DRX cycle threshold, starting monitoring for the wake-up signal during the at least one monitoring occasion; and determining whether to monitor in the first on duration of the DRX pattern based on a monitoring result of the wake-up signal.

In some example embodiments, a configuration of the wake-up signal monitoring rule comprises a threshold number of on durations of the DRX pattern, and the first apparatus further comprises: means for determining, based on the wake-up signal monitoring rule, whether a number of at least one on duration of the DRX pattern other than a first on duration within at least a part of the following active period of the DTX pattern exceeds the threshold number, wherein the first on duration is associated with the at least one monitoring occasion; means for in accordance with a determination that the number of at least one on duration of the DRX pattern exceeds the threshold number, skipping to monitor during the at least one monitoring occasion and the first on duration of the DRX pattern; and starting monitoring for the wake-up signal during a monitoring occasion associated with a second on duration following the first on duration in the following active period of the DTX pattern; and means for in accordance with a determination that the number of at least one on duration of the DRX pattern does not exceed the threshold number, starting monitoring for the wake-up signal during the at least one monitoring occasion; and determining whether to monitor in the first on duration of the DRX pattern based on a monitoring result of the wake-up signal.

In some example embodiments, the part of the following active period of the DTX pattern comprises a DTX window starting from a start time of the following active period of the DTX pattern.

In some example embodiments, a configuration of the wake-up signal monitoring rule comprises a third offset to be applied for monitoring the wake-up signal, and the first apparatus further comprises: means for determining, based on the wake-up signal monitoring rule, whether the at least one monitoring occasion for the wake-up signal occurs within the third offset before a start time of a following active period of the DTX pattern; means for in accordance with a determination that the at least one monitoring occasion occurs within the third offset before the start time of the following active period of the DTX pattern, starting monitoring during the at least one monitoring occasion; and determining whether to monitor in the at least one on duration of the DRX pattern based on a monitoring result of the wake-up signal; and means for in accordance with a determination that the at least one monitoring occasion does not occur within the third offset before the start time of the following active period of the DTX pattern, skipping to monitor during the at least one monitoring occasion and the following on duration of the DRX pattern.

In some example embodiments, a configuration of the wake-up signal monitoring rule comprises a third offset to be applied for monitoring the wake-up signal, and the first apparatus further comprises: means for determining, based on the first configuration and the second configuration, a later start time from a first on duration of the DRX pattern and a following active period of the DTX pattern; means for determining, based on the wake-up signal monitoring rule, whether the at least one monitoring occasion for the wake-up signal occurs within the third offset before the later start time; means for in accordance with a determination that the at least one monitoring occasion occurs within the third offset before the later start time, starting monitoring during the at least one monitoring occasion; and determining whether to monitor in the at least one on duration of the DRX pattern based on a monitoring result of the wake-up signal; and means for in accordance with a determination that the at least one monitoring occasion does not occur within the third offset before the later start time, skipping to monitor during the at least one monitoring occasion and the following on duration of the DRX pattern.

In some example embodiments, the first apparatus further comprises: means for determining, based on the wake-up signal monitoring rule, whether a first on duration of the DRX pattern is within a following active period of the DTX pattern, wherein the at least one monitoring occasion is associated with the following active period of the DTX pattern; means for in accordance with a determination that the first on duration of the DRX pattern is within a following active period of the DTX pattern, starting monitoring during the at least one monitoring occasion; and determining whether to monitor in the at least one on duration of the DRX pattern based on a monitoring result of the wake-up signal; and means for in accordance with a determination that the first on duration of the DRX pattern is not within a following active period of the DTX pattern, skipping to monitor during the at least one monitoring occasion and the following on duration of the DRX pattern.

In some example embodiments, the first apparatus further comprises: means for skipping to monitor the wake-up signal during the at least one monitoring occasion; and means for starting monitoring during a first on duration of the DRX pattern, wherein the first on duration is associated with the at least one monitoring occasion.

In some example embodiments, the first apparatus further comprises: means for determining, based on the wake-up signal monitoring rule, no change in secondary cell dormancy state.

In some example embodiments, the first apparatus further comprises: means for determining, based on the first configuration and the third configuration, the at least one monitoring occasion of a search space for the wake-up signal occurring at least partially within a non-active period of the DTX pattern; means for starting monitoring the wake-up signal during the at least one monitoring occasion based on the wake-up signal monitoring rule; and means for determining whether to monitor in the at least one on duration of the DRX pattern based on a monitoring result of the wake-up signal.

In some example embodiments, the first apparatus further comprises: means for determining, based on the first configuration and the second configuration, a first on duration of the DRX pattern is at least partially overlapped with a non-active period of the DTX pattern; and means for skipping to monitor in the following on duration of the DRX pattern based on the wake-up signal monitoring rule.

In some example embodiments, an apparatus, also referred to as a second apparatus, capable of performing any of the method 900 (for example, the second apparatus 120 in FIG. 1) may comprise means for performing the respective operations of the method 900. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a terminal device served by the second apparatus, a first configuration of a discontinuous transmission, DTX, pattern applied by the second apparatus, a second configuration of a discontinuous reception, DRX, pattern applied by the terminal device, and a third configuration of a wake-up signal associated with the DRX pattern; means for determining whether the terminal device is required to monitor at least partially in at least one on duration of the DRX pattern; and means for in accordance with a determination that at least one monitoring occasion for the wake-up signal occurring at least partially within a non-active period of the DTX pattern, determining, based on the determination result and a wake-up signal monitoring rule, whether to transmit the wake-up signal.

In some example embodiments, the wake-up signal monitoring rule is preconfigured at the first apparatus.

In some example embodiments, the wake-up signal monitoring rule is configured as a part of the first configuration of the DTX pattern or the third configuration of the wake-up signal associated with the DRX pattern.

In some example embodiments, a configuration of the wake-up signal monitoring rule comprises a first offset to be applied for monitoring the wake-up signal, and the second apparatus further comprises: means for determining, based on the wake-up signal monitoring rule, at least one transmission occasion starting from a time that occurs at the first offset before a later start time from a first on duration of the DRX pattern and a following active period of the DTX pattern; means for in accordance with a determination that the terminal device is required to monitor at least partially in at least one on duration of the DRX pattern, transmitting, to the terminal device, the wake-up signal comprising a first indicator during the at least one transmission occasion; and means for in accordance with a determination that the terminal device is not required to monitor at least partially in at least one on duration of the DRX pattern, transmitting, to the terminal device, the wake-up signal comprising a second indicator during the at least one transmission occasion.

In some example embodiments, a configuration of the wake-up signal monitoring rule comprises a first offset to be applied for monitoring the wake-up signal, and the second apparatus further comprises: means for determining, based on the wake-up signal monitoring rule, at least one transmission occasion starting from a time that occurs at the first offset before a start time of a first on duration of the DRX pattern; means for in accordance with a determination that the terminal device is required to monitor at least partially in at least one on duration of the DRX pattern, transmitting, to the terminal device, the wake-up signal comprising a first indicator during the at least one transmission occasion; and means for in accordance with a determination that the terminal device is not required to monitor at least partially in at least one on duration of the DRX pattern, transmitting, to the terminal device, the wake-up signal comprising a second indicator during the at least one transmission occasion.

In some example embodiments, a configuration of the wake-up signal monitoring rule comprises a first offset to be applied for monitoring the wake-up signal, and the second apparatus further comprises: means for determining, based on the wake-up signal monitoring rule, at least one transmission occasion starting from a time that occurs at the first offset before a start time of a following active period of the DTX pattern; means for in accordance with a determination that the terminal device is required to monitor at least partially in at least one on duration of the DRX pattern, transmitting, to the terminal device, the wake-up signal comprising a first indicator during the at least one transmission occasion; and means for in accordance with a determination that the terminal device is not required to monitor at least partially in at least one on duration of the DRX pattern, transmitting, to the terminal device, the wake-up signal comprising a second indicator during the at least one transmission occasion.

In some example embodiments, a configuration of the wake-up signal monitoring rule comprises a second offset to be applied for monitoring the wake-up signal, and the second apparatus further comprises: means for determining, based on the wake-up signal monitoring rule, whether a second on duration following a first on duration in a following active period of the DTX pattern is within the second offset from a start time of the following active period of the DTX pattern; means for in accordance with a determination that the second on duration is within the second offset from the start time of the following active period of the DTX pattern, determining no wake-up signal to be transmitted for the first on duration; and means for in accordance with a determination that the second on duration is not within the second offset from the start time of the following active period of the DTX pattern, transmitting, to the terminal device, the wake-up signal during at least one monitoring occasion configured for the wake-up signal, the wake-up signal indicative of whether to monitor in the first on duration of the DRX pattern.

In some example embodiments, a configuration of the wake-up signal monitoring rule comprises a DRX cycle threshold, and the second apparatus further comprises: means for determining, based on the wake-up signal monitoring rule, whether a DRX cycle of the DRX pattern exceed the DRX cycle threshold; means for in accordance with a determination that the DRX cycle of the DRX pattern does not exceed the DRX cycle threshold, determining no wake-up signal to be transmitted; and means for in accordance with a determination that the DRX cycle of the DRX pattern exceeds the DRX cycle threshold, transmitting, to the terminal device, the wake-up signal during at least one monitoring occasion configured for the wake-up signal, the wake-up signal indicative of whether to monitor in the at least one on duration of the DRX pattern.

In some example embodiments, a configuration of the wake-up signal monitoring rule comprises a threshold number of on durations of the DRX pattern, and the second apparatus further comprises: means for determining, based on the wake-up signal monitoring rule, whether a number of at least one on duration of the DRX pattern other than a first on duration within at least a part of the following active period of the DTX pattern exceeds the threshold number; means for in accordance with a determination that the number of at least one on duration of the DRX pattern exceeds the threshold number, determining no wake-up signal to be transmitted; and means for in accordance with a determination that the number of at least one on duration of the DRX pattern does not exceed the threshold number, transmit, to the terminal device, the wake-up signal during at least one monitoring occasion configured for the wake-up signal, the wake-up signal indicative of whether to monitor in the at least one on duration of the DRX pattern.

In some example embodiments, the part of the following active period of the DTX pattern comprises a DTX window starting from a start time of the following active period of the DTX pattern.

In some example embodiments, a configuration of the wake-up signal monitoring rule comprises a third offset to be applied for monitoring the wake-up signal, and the second apparatus further comprises: means for determining, based on the wake-up signal monitoring rule, whether the at least one monitoring occasion configured for the wake-up signal occurs within the third offset before a start time of a following active period of the DTX pattern; means for in accordance with a determination that the at least one monitoring occasion occurs within the third offset before the start time of the following active period of the DTX pattern, transmitting the wake-up signal before the end of the non-active period of the DTX pattern, the wake-up signal indicative of whether to monitor in the at least one on duration of the DRX pattern; and means for in accordance with a determination that the at least one monitoring occasion does not occur within the third offset before the start time of the following active period of the DTX pattern, determining no wake-up signal to be transmitted.

In some example embodiments, a configuration of the wake-up signal monitoring rule comprises a third offset to be applied for monitoring the wake-up signal, and the second apparatus further comprises: means for determining, based on the first configuration and the second configuration, a later start time from a first on duration of the DRX pattern and a following active period of the DTX pattern; means for determining, based on the wake-up signal monitoring rule, whether the at least one monitoring occasion for the wake-up signal occurs within the third offset before the later start time; means for in accordance with a determination that the at least one monitoring occasion occurs within the third offset before the later start time, transmitting the wake-up signal before the end of an active period of the DTX pattern, the wake-up signal indicative of whether to monitor in the at least one on duration of the DRX pattern; and means for in accordance with a determination that the at least one monitoring occasion does not occur within the third offset before the later start time, determining no wake-up signal to be transmitted.

In some example embodiments, the second apparatus further comprises: means for determining, based on the wake-up signal monitoring rule, whether a first on duration of the DRX pattern is within a following active period of the DTX pattern, wherein the at least one monitoring occasion is associated with the following active period of the DTX pattern; means for in accordance with a determination that the first on duration of the DRX pattern is within a following active period of the DTX pattern, transmitting the wake-up signal before the end of an active period of the DTX pattern, the wake-up signal indicative of whether to monitor in the at least one on duration of the DRX pattern; and means for in accordance with a determination that the first on duration of the DRX pattern is not within a following active period of the DTX pattern, determining no wake-up signal to be transmitted.

In some example embodiments, the second apparatus further comprises: means for determining, based on the wake-up signal monitoring rule, no wake-up signal to be transmitted.

In some example embodiments, the second apparatus further comprises: means for determining, based on the first configuration and the third configuration, the at least one monitoring occasion of a search space for the wake-up signal occurring at least partially within a non-active period of the DTX pattern; and means for transmitting the wake-up signal before the end of an active period of the DTX pattern, the wake-up signal indicative of whether to monitor in the at least one on duration of the DRX pattern.

In some example embodiments, the second apparatus further comprises: means for determining, based on the first configuration and the second configuration, a first on duration of the DRX pattern is at least partially overlapped with a non-active period of the DTX pattern; and means for transmitting the wake-up signal before the end of an active period of the DTX pattern, the wake-up signal indicative of whether to monitor in the at least one on duration of the DRX pattern.

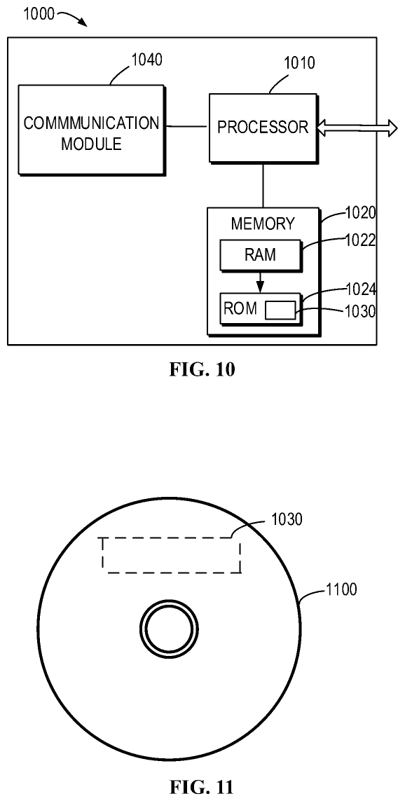

FIG. 10 is a simplified block diagram of a device 1000 that is suitable for implementing example embodiments of the present disclosure. The device 1000 may be provided to implement a communication device, for example, the first apparatus 110, or the second apparatus 120 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 2 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
receive, from a network device serving the apparatus, a first configuration of a discontinuous transmission, DTX, pattern applied by the network device, a second configuration of a discontinuous reception, DRX, pattern applied by the apparatus, and a third configuration of a wake-up signal associated with the DRX pattern;
determine, based at least on the first configuration and the third configuration, at least one monitoring occasion for a wake-up signal occurs at least partially in a non-active period of the DTX pattern; and
in accordance with a determination that the at least one monitoring occasion occurs at least partially in the non-active period of the DTX pattern, determine, based on the first configuration, the second configuration, the third configuration and a wake-up signal monitoring rule, whether to monitor the wake-up signal during at least one monitoring occasion and whether to monitor at least partially in at least one on duration of the DRX pattern.

2. The apparatus of claim 1, wherein the wake-up signal monitoring rule is preconfigured at the apparatus.

3. The apparatus of claim 1, wherein the wake-up signal monitoring rule is configured as a part of the first configuration of the DTX pattern or the third configuration of the wake-up signal associated with the DRX pattern.

4. The apparatus of claim 1, wherein a configuration of the wake-up signal monitoring rule comprises a first offset to be applied for monitoring the wake-up signal, and
wherein the apparatus is further caused to:
determine, based on the wake-up signal monitoring rule, a later start time from a first on duration of the DRX pattern and a following active period of the DTX pattern, wherein the first on duration is associated with the at least one monitoring occasion; and
start monitoring the wake-up signal at a time that occurs at the first offset before the later start time.

5. The apparatus of claim 1, wherein a configuration of the wake-up signal monitoring rule comprises a first offset to be applied to a start time of a first on duration of the DRX pattern associated with the at least one monitoring occasion, and
wherein the apparatus is further caused to:
start monitoring the wake-up signal at a time that occurs at the first offset before the start time of the first on duration of the DRX pattern.

6. The apparatus of claim 1, wherein a configuration of the wake-up signal monitoring rule comprises a first offset to be applied to a start time of a following active period of the DTX pattern, and
wherein the apparatus is further caused to:
start monitoring the wake-up signal at a time that occurs at the first offset before the start time of the following active period of the DTX pattern.

7. The apparatus of claim 1, wherein a configuration of the wake-up signal monitoring rule comprises a second offset to be applied for monitoring the wake-up signal, and
wherein the apparatus is further caused to:
determine, based on the wake-up signal monitoring rule, whether a second on duration following a first on duration in a following active period of the DTX pattern is within the second offset from a start time of the following active period of the DTX pattern, wherein the first on duration is associated with the at least one monitoring occasion;
in accordance with a determination that the second on duration is within the second offset from the start time of the following active period of the DTX pattern,
skip to monitor for the wake-up signal during the at least one monitoring occasion and the first on duration of the DRX pattern; and
start monitoring for the wake-up signal during a monitoring occasion associated with the second on duration in the following active period of the DTX pattern; and
in accordance with a determination that the second on duration is not within the second offset from the start time of the following active period of the DTX pattern,
start monitoring for the wake-up signal during the at least one monitoring occasion; and
determine whether to monitor in the following on duration of the DRX pattern based on a monitoring result of the wake-up signal.

8. The apparatus of claim 1, wherein a configuration of the wake-up signal monitoring rule comprises a DRX cycle threshold, and
wherein the apparatus is further caused to:
determine, based on the wake-up signal monitoring rule, whether a DRX cycle of the DRX pattern exceed the DRX cycle threshold;
in accordance with a determination that the DRX cycle of the DRX pattern does not exceed the DRX cycle threshold,
skip to monitor for the wake-up signal during the at least one monitoring occasion and a first on duration of the DRX pattern associated with the at least one monitoring occasion; and
start monitoring for the wake-up signal during a monitoring occasion associated with a second on duration following the first on duration in the following active period of the DTX pattern; and
in accordance with a determination that the DRX cycle of the DRX pattern exceeds the DRX cycle threshold,
start monitoring for the wake-up signal during the at least one monitoring occasion; and
determine whether to monitor in the first on duration of the DRX pattern based on a monitoring result of the wake-up signal.

9. The apparatus of claim 1, wherein a configuration of the wake-up signal monitoring rule comprises a threshold number of on durations of the DRX pattern, and
wherein the apparatus is further caused to:
determine, based on the wake-up signal monitoring rule, whether a number of at least one on duration of the DRX pattern other than a first on duration within at least a part of the following active period of the DTX pattern exceeds the threshold number, wherein the first on duration is associated with the at least one monitoring occasion;
in accordance with a determination that the number of at least one on duration of the DRX pattern exceeds the threshold number,
skip to monitor during the at least one monitoring occasion and the first on duration of the DRX pattern; and
start monitoring for the wake-up signal during a monitoring occasion associated with a second on duration following the first on duration in the following active period of the DTX pattern; and
in accordance with a determination that the number of at least one on duration of the DRX pattern does not exceed the threshold number,
start monitoring for the wake-up signal during the at least one monitoring occasion; and
determine whether to monitor in the first on duration of the DRX pattern based on a monitoring result of the wake-up signal.

10. The apparatus of claim 9, wherein the part of the following active period of the DTX pattern comprises a DTX window starting from a start time of the following active period of the DTX pattern.

11. The apparatus of claim 1, wherein a configuration of the wake-up signal monitoring rule comprises a third offset to be applied for monitoring the wake-up signal, and
wherein the apparatus is further caused to:
determine, based on the wake-up signal monitoring rule, whether the at least one monitoring occasion for the wake-up signal occurs within the third offset before a start time of a following active period of the DTX pattern;
in accordance with a determination that the at least one monitoring occasion occurs within the third offset before the start time of the following active period of the DTX pattern,
start monitoring during the at least one monitoring occasion; and
determine whether to monitor in the at least one on duration of the DRX pattern based on a monitoring result of the wake-up signal; and
in accordance with a determination that the at least one monitoring occasion does not occur within the third offset before the start time of the following active period of the DTX pattern, skip to monitor during the at least one monitoring occasion and the following on duration of the DRX pattern.

12. The apparatus of claim 1, wherein a configuration of the wake-up signal monitoring rule comprises a third offset to be applied for monitoring the wake-up signal, and
wherein the apparatus is further caused to:
determine, based on the first configuration and the second configuration, a later start time from a first on duration of the DRX pattern and a following active period of the DTX pattern;
determine, based on the wake-up signal monitoring rule, whether the at least one monitoring occasion for the wake-up signal occurs within the third offset before the later start time;
in accordance with a determination that the at least one monitoring occasion occurs within the third offset before the later start time,
start monitoring during the at least one monitoring occasion; and
determine whether to monitor in the at least one on duration of the DRX pattern based on a monitoring result of the wake-up signal; and
in accordance with a determination that the at least one monitoring occasion does not occur within the third offset before the later start time, skip to monitor during the at least one monitoring occasion and the following on duration of the DRX pattern.

13. The apparatus of claim 1, wherein the apparatus is further caused to:
determine, based on the wake-up signal monitoring rule, whether a first on duration of the DRX pattern is within a following active period of the DTX pattern, wherein the at least one monitoring occasion is associated with the following active period of the DTX pattern;
in accordance with a determination that the first on duration of the DRX pattern is within a following active period of the DTX pattern,
start monitoring during the at least one monitoring occasion; and
determine whether to monitor in the at least one on duration of the DRX pattern based on a monitoring result of the wake-up signal; and
in accordance with a determination that the first on duration of the DRX pattern is not within a following active period of the DTX pattern, skip to monitor during the at least one monitoring occasion and the following on duration of the DRX pattern.

14. The apparatus of claim 1, wherein the apparatus is further caused to:
skip to monitor the wake-up signal during the at least one monitoring occasion; and
start monitoring during a first on duration of the DRX pattern, wherein the first on duration is associated with the at least one monitoring occasion.

15. The apparatus of claim 1, wherein the apparatus is further caused to:
determine, based on the wake-up signal monitoring rule, no change in secondary cell dormancy state.

16. The apparatus of claim 1, wherein the apparatus is further caused to:
determine, based on the first configuration and the third configuration, the at least one monitoring occasion of a search space for the wake-up signal occurring at least partially within a non-active period of the DTX pattern;
start monitoring the wake-up signal during the at least one monitoring occasion based on the wake-up signal monitoring rule; and
determine whether to monitor in the at least one on duration of the DRX pattern based on a monitoring result of the wake-up signal.

17. The apparatus of claim 1, wherein the apparatus is further caused to:
determine, based on the first configuration and the second configuration, a first on duration of the DRX pattern is at least partially overlapped with a non-active period of the DTX pattern; and
skip to monitor in the following on duration of the DRX pattern based on the wake-up signal monitoring rule.

18. An apparatus comprising:
at least one processor; and
at least one memory storing instructions that, when executed by the at least one processor, cause the apparatus at least to:
transmit, to a terminal device served by the apparatus, a first configuration of a discontinuous transmission, DTX, pattern applied by the apparatus, a second configuration of a discontinuous reception, DRX, pattern applied by the terminal device, and a third configuration of a wake-up signal associated with the DRX pattern;
determine whether the terminal device is required to monitor at least partially in at least one on duration of the DRX pattern; and
in accordance with a determination that at least one monitoring occasion for the wake-up signal occurring at least partially within a non-active period of the DTX pattern, determine, based on the determination result and a wake-up signal monitoring rule, whether to transmit the wake-up signal.

19-30. (canceled)

31. The apparatus of claim 18, wherein the apparatus is caused to:
determine, based on the wake-up signal monitoring rule, no wake-up signal to be transmitted.

32-33. (canceled)

34. A method comprising:
receiving, at a terminal device and from a network device serving the terminal device, a first configuration of a discontinuous transmission, DTX, pattern applied by the network device, a second configuration of a discontinuous reception, DRX, pattern applied by the terminal device, and a third configuration of a wake-up signal associated with the DRX pattern; and
determining, based at least on the first configuration and the third configuration, at least one monitoring occasion for a wake-up signal occurs at least partially in a non-active period of the DTX pattern; and
in accordance with a determination that the at least one monitoring occasion occurs at least partially in the non-active period of the DTX pattern, determining, based on the first configuration, the second configuration, the third configuration and a wake-up signal monitoring rule, whether to monitor the wake-up signal during at least one monitoring occasion and whether to monitor at least partially in at least one on duration of the DRX pattern.

35-38. (canceled)
